(19) United States
(12) Patent Application Publication
(10) Pub. No.: US 2012/0148790 A1
(43) Pub. Date: Jun. 14, 2012

(54) REINFORCEMENT COMPRISING PARALLEL ROVINGS OF GLASS STRANDS

(76) Inventor: Gilbert Chomarat, Cologny (CH)

(21) Appl. No.: 13/391,112

(22) PCT Filed: Aug. 11, 2010
(86) PCT No.: PCT/IB2010/053636

§ 371 Date: Feb. 17, 2012

(30) Foreign Application Priority Data
Aug. 21, 2009 (FR) 09 04030

(51) Int. Cl. B32B 17/06; B32B 37/04; B32B 38/00; B32B 5/06

(52) U.S. Cl. 428/113; 442/367; 428/340; 442/335; 428/219; 156/148

(57) ABSTRACT

A reinforcement layer (2) is based on parallel rovings (2a) of continuous glass strands, and one or two binding layers (3) consisting of portions of fibers having a heat-meltable surface. The assembly is consolidated by penetrating fiber portions (3b) that penetrate into the heat-meltable surface, these penetrating over a part of their length into the reinforcement layer (2) and adhering to the continuous glass strands of the rovings (2a).

### TECHNICAL FIELD OF THE INVENTION

The present invention relates to coherent and flexible textile armatures used as reinforcing products for composite items, i.e. for items based on (polyester or others) resin reinforced with reinforcing fibers.

Numerous coherent textile armature reinforcing structures made of one or more layers of fibers coupled together are already known. The textile armature generally takes the form of a flexible lap packaged in a reel, that can thus be transported and handled at the site on which it is used in order to produce a composite item.

In order to produce a composite item, the procedure is generally as follows: a piece of textile armature of suitable surface area is cut out and placed in a mold, and a resin is then introduced into the mold to enclose the textile armature. After polymerization, the resin and the insert form a structure that is mechanically strong.

The mechanical strength properties are obtained only provided that the resin perfectly penetrates between the fibers that make up the insert, without leaving any regions that are free of resin, and on the proviso that it adheres perfectly to the fibers. It is also necessary for the fibers to occupy uniformly the volume of the composite item that is to be produced, notably by conforming to the shape of the item when the item is not planar.

It is finally necessary for the fibers themselves to have enough mechanical strength that they can form an effective reinforcing insert.

Various reinforcing textile armature structures have already been proposed.

Thus, document EP 0 395 548 describes the use of two layers of textile armature, for example made of fiberglass, positioned one on each side of a central layer made of a lap based on synthetic fibers with a permanent crimp, for example polyester fibers 40 to 70 mm long which have undergone a texturizing treatment. The layers of textile armature are coupled to the central layer by stitching/knitting.

Document EP 0 694 643 describes the use of two textile reinforcing layers positioned one on each side of a central layer that provides said material with thickness, the layers being coupled to one another by stitching/knitting, and a bonded or stitched-on web of synthetic fibers is provided against one of the external faces.

Stitching/knitting techniques are relatively slow and the textile armatures thus produced have non-uniform deformability and present defects of appearance at their surface.

In order to increase production rates and reduce the defects that result from a knitting operation, FR 2 916 208 A1 and WO 2008/139423 A1 have recently proposed the production of a fiber-based textile armature comprising a thick and aerated internal layer based on 90 mm portions of synthetic fibers which have undergone a treatment that gives them a permanent crimp, and external layers positioned one on each side of the internal layer and comprising 50 mm reinforcing fibers and portions of fibers with hot melt surface. At least some of the portions of fiber with hot melt surface over part of their length penetrate the internal layer and adhere partially to one another and to the synthetic fibers of the internal layer.

One benefit of this structure is that it gives the textile armatures a great deal of flexibility and good deformability so that they can conform to the shapes of complex molds, the crimped synthetic fibers ensuring that the internal layer maintains sufficient volume for correct penetration of the resin during the subsequent molding operation.

The reinforcing fibers such as the 50 mm lengths of glass fibers present in the external layers improve the mechanical properties of the composite item. However, this improvement is slight, because these reinforcing fibers are short and of necessity are in small quantities, the proportion of glass fibers being limited by the predominant presence of the synthetic fibers with the permanent crimp. For certain applications it is still desirable to obtain a substantial improvement in the mechanical properties of the composite item, notably its yield or bending strength.

According to a long-known technique described in document FR 1 394 271 A, covered again more recently in document EP 1 125 728 A1, parallel glass fiber rovings taken from a reel, are laid side by side in a lap and made to adhere to a support made of woven or nonwoven fibers that assembles them. Such rovings laid side by side constitute a continuous strip-like structure with a weight of 500 to 1 500 g/m².

A collection of individual glass filaments, generally of a diameter of 5 μm to 24 μm is known as a strand. A strand generally comprises of the order of 40 filaments. A collection of strands is known as a roving. A roving generally contains around 50 strands.

The disadvantage with this known technique is still the necessary presence of an adhesive to provide the reinforcing product with cohesion while it is being handled prior to the injection-molding step. The problem is that the adhesive is liable to reduce the ability of the resin to penetrate during the molding step and to reduce the short-term or long-term mechanical strength of the composite item produced by the molding.

Hitherto, in coherent reinforcements based on unidirectional rovings of glass fibers, the rovings have been assembled by stitching, which is a relatively slow process, and there is a need appreciably to improve the speed of production of the textile reinforcements, in order to achieve production rates in excess of 10 m/min.

The invention addresses these difficulties and finds a solution to them.

### SUMMARY OF THE INVENTION

The problem addressed by the present invention is that of appreciably improving the mechanical strength of the composite items produced from glass fiber molding reinforcements while at the same time maintaining the coherence, flexibility and deformability properties displayed by the molding reinforcements prior to molding, and maintaining good properties regarding the penetration and impression of the resin at the time of molding.

At the same time, the invention seeks to design a molding of reinforcement that can be produced at high speed, reaching production rates in excess of 10 m/min.

In addition, the invention proposes to improve, where necessary, the uniformity of the surface of the composite items produced by molding from the molding reinforcements.

For preference, the invention also seeks to allow the production of reinforcing products as a continuous strip, that can be packaged as a reel, and that can be cut or chopped without the risk of the edges becoming damaged or frayed.

In order to achieve these objectives and others, the invention proposes a molding reinforcement made of a fiber-based lap, comprising:
a first layer of fibers,
at least one coupling layer made of portions of fibers with a hot melt surface, coupled to the first layer of fibers,
at least some of the portions of fibers with hot melt surface penetrating the first layer of fibers over part of their length and adhering partially to one another and to the fibers of the first layer of fibers,

and in which the first layer of fibers comprises rovings of parallel glass strands arranged side by side in a lap, thus forming a reinforcing layer.

The fibers with hot melt surface in the coupling layer provide effective coupling between the rovings of glass fibers without the external addition of adhesive, while at the same time maintaining the flexibility and uniformity of the molding reinforcement, and without deforming or breaking the glass strands.

At the same time, such a structure of molding reinforcement can be produced at high speed, because the interpenetration of the fibers with hot melt surface can be obtained by a light needling step, which is far quicker than the stitching method.

Preferably, the portions of fibers with hot melt surface that penetrate the reinforcing layer are relatively widely spaced, this spacing being equal to or greater than the spacing of the needles used for a light needling operation: the surface density of such a light needling operation is around 5 to 10 needle penetrations per cm² of reinforcing layer. This results in lower bending stresses being applied to the glass fibers, and in a corresponding reduction in the risks of the glass fibers breaking.

The invention thus makes it possible to use the excellent mechanical properties of the unidirectional rovings of glass strands, conferring excellent mechanical properties on the composite items produced by molding such a reinforcement. The coupling layer, certain portions of fibers of which penetrate and adhere to the fibers in the reinforcing layer, temporarily holds the glass strands of the reinforcing layer together firmly enough after manufacture and prior to use of the molding reinforcement that the molding reinforcement presents satisfactory cohesion.

At the same time, the coupling layer with penetrating and adhering fibers allows the glass strands to be held together with only a small quantity of material other than glass, i.e. while maximizing the relative proportion of glass in the molding reinforcement.

The coupling layer can be particularly thin, in the form of a web of fibers, for example as a grammage of the order of 25 to 30 g/m².

The rovings of glass strands may advantageously have a count of between around 2 400 and 4 800 tex.

In such a roving, the glass strands may advantageously be formed of an assembly of filaments of individual diameter ranging between around 14 μm and around 17 μm.

As an alternative or in addition, the glass strands of the rovings may have an individual count of around 40 to 80 tex.

According to a first embodiment, the reinforcing layer is coupled to a single coupling layer of fibers with hot melt surface.

According to a second embodiment, the reinforcing layer is coupled to two coupling layers made of fibers with hot melt surface, which are arranged one on each side of the reinforcing layer.

According to a third embodiment in a structure of one of the previous embodiments, there is also an intermediate layer of glass strands between the reinforcing layer and the coupling layer.

The intermediate layer may comprise a layer of glass strands of around 160 to 200 tex, which are parallel and oriented perpendicular to the rovings, and/or a layer of chopped glass fibers measuring around 50 mm, applied in bulk at all orientations at a grammage of around 50 to 80 g/m².

Advantageously, the molding reinforcement according to the invention may have a grammage of between 400 and 1 800 g/m². This then is a good compromise between the thickness of the molding reinforcement and its ability to deform prior to molding. By way of example, using five rovings of 2 400 tex per cm a grammage of 1 200 g/m² is achieved.

According to another aspect, the invention provides a method of manufacturing such a molding reinforcement, comprising the steps of:

a) laying a plurality of parallel glass strand rovings side by side on a support to form a lap of glass strand rovings constituting a reinforcing layer,

b) laying a web of chemical fibers with hot melt surface, on the reinforcing layer, to constitute a coupling layer,

c) performing a light needling operation to cause the portions of fibers with hot melt surface in the coupling layer to penetrate the reinforcing layer,

d) heating the whole assembly to a temperature high enough to soften the fibers with hot melt surface and make them sticky,

e) cold rolling the assembly.

In the case of a reinforcement with two coupling layers, in step a) a second web of chemical fibers of hot melt surface, constituting a second coupling layer, is laid on the support then the rovings of glass strands are laid on the second coupling layer; in step c) a double-sided light needling operation is performed.

In the case of a reinforcement having an intermediate layer, the precut glass strands or fibers of the intermediate layer are placed on the reinforcing layer between step a) and step b).

Preferably, during the light needling step, use is made of needles the driving beards of which are positioned in a diametral plane parallel to the direction of the strands of the glass strand rovings. In that way, it is possible to avoid breaking the glass strands, and it is possible to guarantee that the reinforcement obtained will afford great mechanical strength to the composite items made from such a reinforcement.

### BRIEF DESCRIPTION OF THE DRAWINGS

Other objects, features and advantages of the present invention will emerge for the following description of particular embodiments, which is given in conjunction with the attached figures, among which:

FIG. 1 is a schematic view in longitudinal section of a molding reinforcement according to a first embodiment of the invention;

FIG. 2 is a schematic perspective view of a roving of continuous glass strands, partially exploded;

FIG. 3 is a perspective view of a continuous glass strand;

FIG. 4 is a schematic view in longitudinal section of the molding reinforcement in FIG. 1, during a light needling operation;

FIG. 5 is a schematic perspective view of a molding reinforcement according to one embodiment of the invention;

FIG. 6 illustrates the orientation of the driving beards of the needles during the light needling operation;

FIG. 7 is a schematic view in longitudinal section of a molding reinforcement according to another embodiment of the invention; and

FIG. 8 is a schematic view in longitudinal section of a molding reinforcement according to another embodiment of the invention.

### DESCRIPTION OF PREFERRED EMBODIMENTS

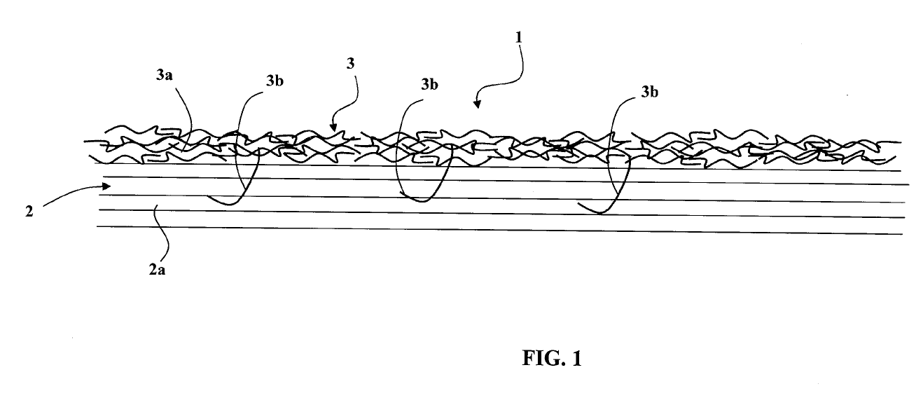

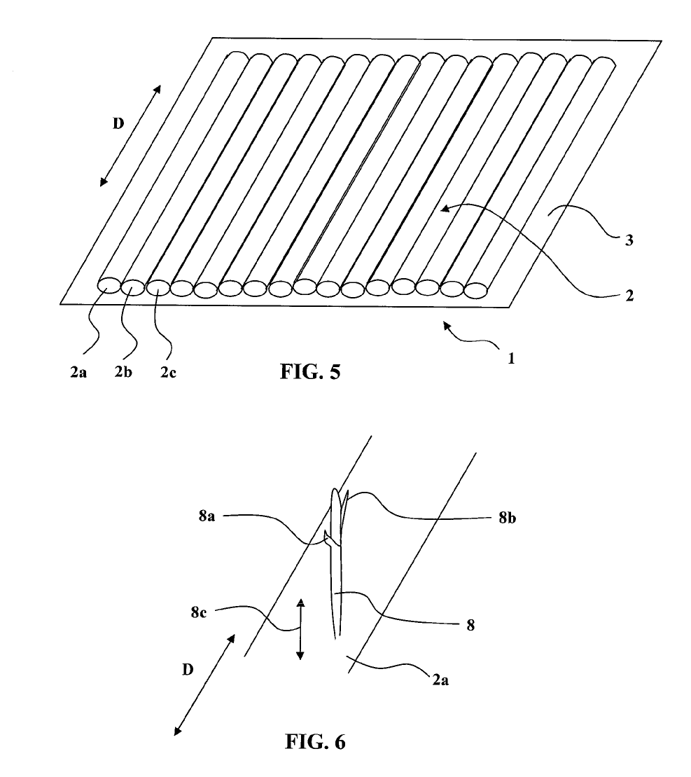

In a first embodiment illustrated in FIGS. 1 and 5, a molding reinforcement 1 according to the invention comprises two layers of fibers, namely one reinforcing layer 2 and one coupling layer 3.

The reinforcing layer 2 comprises rovings of glass strands, such as the rovings 2a, 2b, 2c (FIG. 5), which are parallel and placed side by side in a lap as a single thickness of rovings.

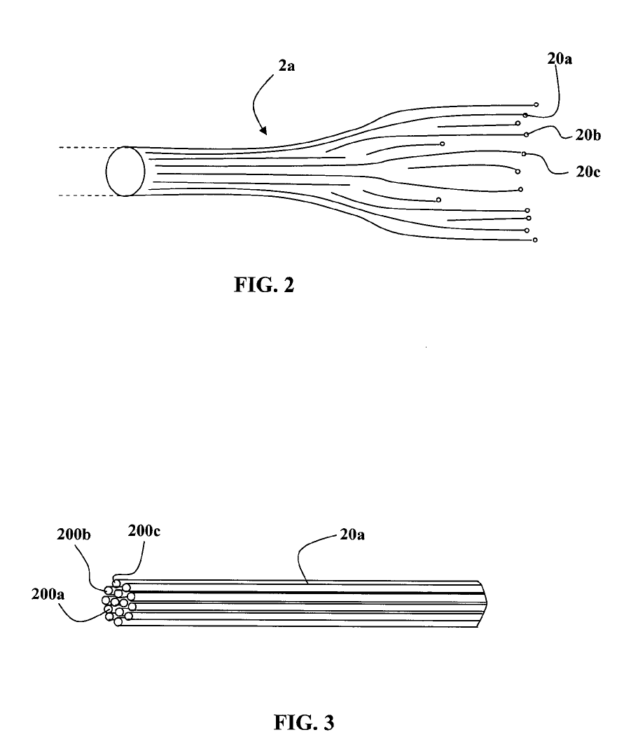

By way of illustration, FIG. 2 depicts such a roving 2a or bundle of strands such as the strands 20a, 20b, 20c, which are generally parallel to one another. Within the roving 2a, the continuous strands 20a, 20b, 20c are normally in contact with one another. FIG. 2 illustrates the roving 2a partially exploded, the strands 20a, 20b, 20c divergent from one another in the right-hand part of the figure, to provide a better understanding of the structure of the roving. In a molding reinforcement, the strands 20a, 20b, 20c remain in contact with one another.

In order to obtain good mechanical tensile strength, assemblies of continuous glass strands 20a (FIG. 3) taken from a reel or “roving” will advantageously be chosen. The strands are formed of an assembly of filaments such as the filaments 200a, 200b, 200c, the individual diameter of which is between around 14 μm and around 17 μm. The individual count of the glass strands 20a, 20b, 20c may for example range between 40 and 80 tex, by assembling around 50 glass filaments.

The strands 20a, 20b, 20c are in actual fact made up of enough filaments that they will not break during the handlings and uses according to the invention, it being pointed out that the individual filaments alone, at the size at which they usually leave the manufacturing dies, are too fragile to be handled and used in such a way.

As an alternative, in order to achieve the possibility of stretching out the molding reinforcement 1 prior to the molding step, the rovings chosen will advantageously be rovings of chopped glass strands, around 10 cm to 100 cm long, it being possible for the strands to move longitudinally relative to one another such that they overlap, each remaining formed of an assembly of filaments. Such strands are long enough to guarantee the composite item produced by molding this molding reinforcement 1 good mechanical properties, and the ability to stretch out improves suitability for an existing object, for example a tube, to cover the exterior or interior surface thereof. This embodiment for example allows an application to the renovation of underground piping.

The coupling layer 3 contains portions of fibers 3a with hot melt surface.

The portions of fibers 3a with hot melt surface may be made of any material that has a sufficiently low melting point and good properties of adhesion to the glass strands 20a, 20b, 20c of the reinforcing layer 2.

As an alternative, the portions of fibers 3a with hot melt surface may be two-component chemical fibers comprising a central core made of polyamide, polyester or polypropylene, and an external sheath made of copolyester, of polyethylene, or of any other material that has a melting point lower than that of the central core. Good results may be achieved using a central core made of polyester and an external sheath made of copolyester, or a central core made of polypropylene and an external sheath made of polyethylene. Other pairs of materials could be used in the form of coaxial two-component fibers: polypropylene and copolypropylene, polypropylene and ethyl vinyl acetate.

Because the central core of the two-component fiber has a higher melting point than the external sheath, the risk of accidentally completely melting the first portions of fiber with hot melt surface during manufacture of the molding reinforcement 1 is avoided.

The risk of the portions of hot melt fiber, through excessive or uncontrolled heating during a step of heating to manufacture the molding insert 1, becoming completely melted, thereby forming uniform layers or layers that are impermeable to the resin through the spreading of their constituent material over the upper and lower faces of the reinforcing layer 2 is also effectively limited. The core of the two-component fibers is not impaired (or is impaired only very little) and the properties of the coupling layer 3 are thus maintained.

Further, the use of two-component fibers of hot melt surface with an external sheath and a central core means that the polyolefin content of the molding reinforcement 1 can be reduced. That is advantageous because the resin is not very compatible with polyolefins.

Of the portions of fibers 3a with hot melt surface in the coupling layer 3, at least some, for example the penetrating portions 3b in FIG. 1, over part of their length penetrate the reinforcing layer 2 and adhere partially with one another and with the glass strands 20a, 20b, 20c of the reinforcing layer 2.

The penetrating portions 3b of fibers are uniformly distributed over the surface of the molding reinforcement 1, for example at a surface density of 5 to 10 portions per cm² of molding reinforcement, and provide the whole assembly with cohesion, while at the same time maintaining the deformability and flexibility properties of the molding reinforcement 1.

The molding reinforcement 1 according to the invention can be produced in the form of a continuous strip that is packaged as a great long reel. In such a continuous strip, the rovings 2a, 2b, 2c are formed of continuous glass strands 20a, 20b, 20c and are oriented in a lengthwise direction, or warp direction, of the strip.

For example, a lap of rovings of glass strands is laid on a flat support to constitute the reinforcing layer 2, a web of fibers of hot melt surface is laid on the reinforcing layer 2 to form the coupling layer 3.

The whole assembly thus obtained is subjected to a light needling operation which causes at least some 3b of the portions of fibers 3a with a hot melt surface of the coupling layer to penetrate the reinforcing layer 2, the whole assembly is heated to a temperature high enough to soften the hot melt part of the penetrating portions 3b of fibers of hot melt surface and to ensure that, after cooling, they adhere to the glass strands 20a, 20b, 20c of the reinforcing layer 2.

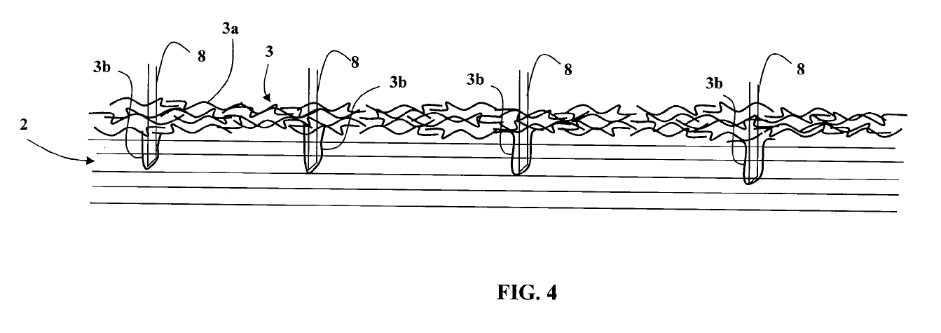

FIG. 4 schematically illustrates the light needling operation and shows the pre-needling needles 8, which drive penetrating portions 3b of fibers with a hot melt surface to cause them to penetrate the reinforcing layer 2.

The light needling operation performed achieves, for example, a perforation surface density of around 5 to 10 perforations per cm². That should be compared against needling methods which, conventionally, achieve densities at least 10 times as high. The light needling operation allows a high throughput during manufacturing of the molding reinforcement according to the invention.

As illustrated in FIG. 6, during the light needling operation, the driving beards, such as the beards 8a and 8b of the needles 8 are positioned in a diametral plane containing the axis of the needle and parallel to the direction D of the stands of the rovings of glass strands such as the roving 2a. As a result of the axial movement (arrow 8c) of the needle 8 during needling, the beards 8a and 8b pass through the rovings 2a, separating the stands 20a, 20b, 20c (FIG. 2) without breaking them.

A light needling operation performed is enough to ensure that the rough molding reinforcement maintains sufficient cohesion while it is being transferred to the next work station, but is not enough to give the molding reinforcement 1 permanent cohesion and this reinforcement can still not be transported out of the needling machinery for use as a reinforcing product.

The heating operation carried out after the light needling operation softens the hot melt surface layer of the penetrating portions 3b of fibers in the coupling layer 3 to make them sticky. The penetrating portions 3b of fibers that have been driven in by the needles 8 of the light needling operation adhere to the glass strands 20a, 20b, 20c of the reinforcing layer 2. After cooling, the various layers 2, 3 of the molding reinforcement 1 are thus coupled together by the needled and bonded fibers 3b. The molding reinforcement 1 can then be transported. The heating is regulated so as to soften the penetrating portions 3b of fibers of hot melt surface and make them sticky, but without melting them.

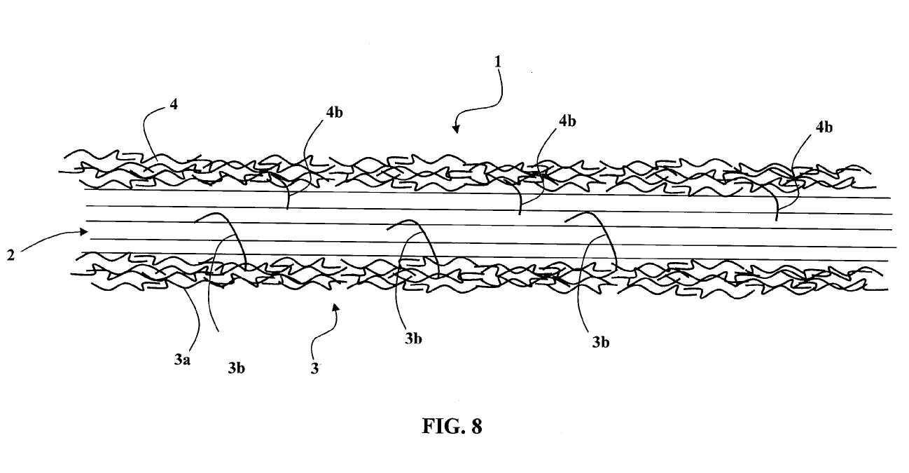

Consideration is now given to FIG. 8 which schematically illustrates a second embodiment of the molding reinforcement according to the invention.

This second embodiment differs from the first embodiment of FIG. 1 through the additional presence of a second coupling layer 4 on the other face of the reinforcing layer 2. Each coupling layer 3 or 4 is based on fibers with a hot melt surface.

Again there are penetrating portions 3b and 4b of fibers of hot melt surface, which join the layers 2, 3 and 4 together.

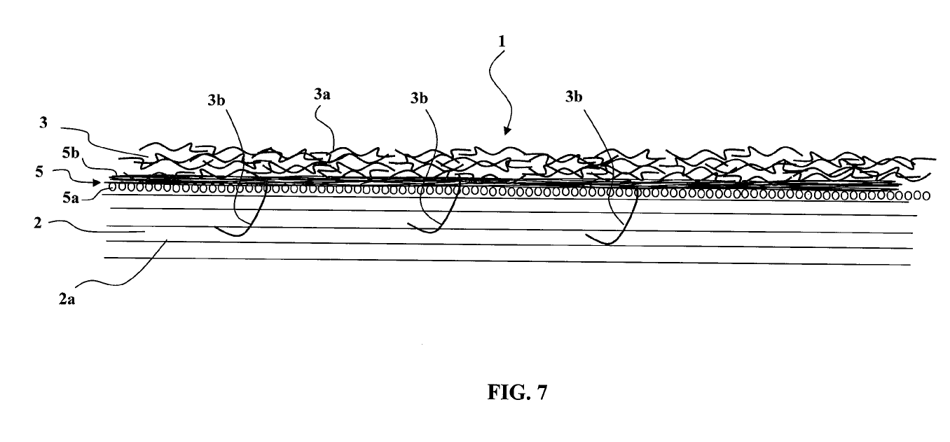

Consideration is now given to FIG. 7 which schematically illustrates a third embodiment of a molding reinforcement according to the invention.

This third embodiment differs from the first embodiment of FIG. 1 through the additional presence of an intermediate layer 5 of glass strands between the reinforcing layer 2 and the coupling layer 3.

In a first option, the intermediate layer 5 comprises a layer 5a of glass strands of around 160 to 200 tex, which are parallel and oriented perpendicular to the rovings 2a, 2b and 2c, i.e. in the weft direction, and which are continuous across the entire width of the reinforcement.

In a second option, the intermediate layer 5 comprises a layer 5b of approximately 50 mm chopped glass fibers, applied in bulk in all orientations, at a grammage of around 50 to 80 g/m².

According to third option, illustrated in FIG. 7, the intermediate layer 5 comprises a layer 5a of glass strands in the weft direction and a layer 5b of chopped glass fibers applied in bulk.

This third embodiment is suited to applications that require transverse reinforcement in the weft direction and may improve the surface uniformity of the composite item.

Again there are penetrating portions 3b of fibers of hot melt surface which join the layers 2, 3 and 5 together.

### Example

I) several rovings of glass strands are laid on a flat support, laying them parallel in a lap in a single thickness to constitute a reinforcing layer 2. The glass strands are formed of an assembly of 40 filaments having an individual diameter of around 15 μm, the strands having an individual count of around 50 tex. The rovings have a count of 2 400 tex, and are present at a rate of five rovings per cm.

II) a web of chemical fibers with a hot melt surface is created on a conventional card. The portions of chemical fibers are made of two-component fibers with a polyester central core and hot melt external sheath made of copolyester. The hot melt external sheath made of copolyester has a melting point of around 110° C.

The two-component chemical fibers have an individual count of between around 2 denier and around 4 denier.

III) the web of chemical fibers with hot melt surface is laid on the reinforcing layer 2.

IV) the rough molding reinforcement thus produced is introduced using a conveyer belt in to a needling machine. The needle density is 10/cm². The depth to which the needles penetrate is 12 mm. The rate of travel of the belt is 20 m/minute.

V) after the light needling operation, the rough molding reinforcement is introduced into a through-air oven comprising a heating part 12 m long at a rate of travel of 20 m/minute. The temperature of the through-air oven is around 120° C.

VI) on leaving the through-air oven, the molding reinforcement 1 is cold-rolled to its final thickness of around 4 to 5 mm.

The grammage of the molding reinforcement 1 is between around 400 and 1 800 g/m².

The molding reinforcement 1 according to the invention may have advantageous applications in the manufacture of long composite components, notably wind turbine blades.

The present invention is not restricted to the embodiments explicitly described but includes the various variations and generalizations thereof which are contained within the scope of the claims that follow.

1. A molding reinforcement (1) made of a fiber-based lap, comprising:
a first layer of fibers (2),
at least one coupling layer (3) made of portions of fibers (3a) with a hot melt surface, coupled to the first layer of fibers (2),
at least some (3b) of the portions (3a) of fibers with hot melt surface penetrating the first layer of fibers (2) over part of their length and adhering partially to one another and to the fibers of the first layer of fibers (2),
wherein the first layer of fibers (2) comprises rovings (2a, 2b, 2c) of parallel glass strands (20a, 20b, 20c) arranged side by side in a lap, thus forming a reinforcing layer.

2. A molding reinforcement as claimed in claim 1, wherein the rovings (2a, 2b, 2c) of glass strands have a count of around 2 400 to 4 800 tex.

3. A molding reinforcement as claimed in claim 1, wherein the glass strands (20a, 20b, 20c) of the rovings (2a, 2b, 2c) are formed of an assembly of filaments of individual diameter ranging between around 14 μm and around 17 μm.

4. A molding reinforcement as claimed in claim 1, wherein the glass strands (20a, 20b, 20c) of the rovings (2a, 2b, 2c) have an individual count of around 40 to 80 tex.

5. A molding reinforcement as claimed in claim 1, wherein the penetrating portions of fibers are distributed with a surface density of 5 to 10 portions per cm² of molding reinforcement.

6. A molding reinforcement as claimed in claim 1, comprising an intermediate layer (5) of glass strands between the reinforcing layer (2) and the coupling layer (3).

7. A molding reinforcement as claimed in claim 6, wherein the intermediate layer (5) comprises a layer (5a) of glass strands of around 160 to 200 tex, which are parallel and oriented perpendicular to the rovings (2a, 2b, 2c), and/or a layer (5b) of chopped glass fibers around 50 mm long applied in bulk in all orientations, at a grammage of around 50 to 80 g/m².

8. A molding reinforcement as claimed in claim 1, wherein the reinforcing layer (2) is coupled to a single coupling layer (3) of fibers with hot melt surface.

9. A molding reinforcement as claimed in claim 1, wherein the reinforcing layer (2) is coupled to two coupling layers (3, 4) made of fibers with hot melt surface, which are arranged one on each side of the reinforcing layer (2).

10. A molding reinforcement as claimed in claim 1, having a grammage of between 400 and 1 800 g/m².

11. A molding reinforcement as claimed in claim 1, being in the form of a continuous strip packaged in a reel, the rovings (2a, 2b, 2c) being formed of continuous glass strands (20a, 20b, 20c) and being oriented in the lengthwise direction of the strip.

12. A molding reinforcement as claimed in claim 1, being in the form of a continuous strip packaged as a reel, the rovings (2a, 2b, 2c) being formed of chopped glass strands 10 to 100 cm long and oriented in the lengthwise direction of the strip.

13. A method of manufacturing a molding reinforcement as claimed in claim 1, comprising the steps of:
a) laying a plurality of parallel glass strand rovings (2a, 2b, 2c) side by side on a support to form a lap of glass strand rovings constituting a reinforcing layer (2),
b) laying a web of chemical fibers with hot melt surface (3a) on the reinforcing layer (2) to constitute a coupling layer (3),
c) performing a light needling operation to cause the portions (3b) of fibers with hot melt surface in the coupling layer (3) to penetrate the reinforcing layer (2),
d) heating the whole assembly to a temperature high enough to soften the fibers (3a) with hot melt surface and make them sticky,
e) cold rolling the assembly.

14. A method as claimed in claim 13, wherein, during the light needling step c), use is made of needles (8) the driving beards (8a, 8b) of which are positioned in a diametral plane parallel to the direction (D) of the strands of the glass strand rovings (2a, 2b, 2c).

15. An application of a molding reinforcement as claimed in claim 1 to the manufacture of wind turbine blades or other long composite components.
